(19) United States
(12) Patent Application Publication
(10) Pub. No.: US 2026/0266000 A1
(43) Pub. Date: Sep. 10, 2026

(54) COATED CELLULOSIC STRUCTURES

(71) Applicant: WestRock MWV, LLC, Atlanta, GA (US)

(72) Inventors: Steven G. BUSHHOUSE, Quinton, VA (US); Gary P. FUGITT, Rockville, VA (US); Scott E. GINTHER, Moseley, VA (US)

(21) Appl. No.: 18/875,652

(22) PCT Filed: Apr. 19, 2023
(86) PCT No.: PCT/US2023/065930

§ 371 Date: Dec. 16, 2024

Related U.S. Application Data
(60) Provisional application No. 63/352,598, filed on Jun. 15, 2022.

(51) Int. Cl. D21H 19/40; D21H 19/54

(52) U.S. Cl. CPC D21H 19/40; D21H 19/54

(57) ABSTRACT

A coated cellulosic structure includes a cellulosic substrate and a basecoat applied to the cellulosic substrate to yield a basecoat outer surface. The basecoat includes a water-soluble polymer binder and pigment.

### PRIORITY

This application claims priority from U.S. Ser. No. 63/352,598 filed on Jun. 15, 2022, the entire contents of which are incorporated herein by reference.

### FIELD

The present application relates to the field of coated cellulosic structures.

### BACKGROUND

Paper and paperboard substrates can be coated with one or more layers, including latex binder and pigment. Compostability of such coated paper and paperboard structures is limited by the presence of the latex binder. There is a need for cellulosic structures that are more compostable.

Accordingly, those skilled in the art continue with research and development in the field of coated cellulosic structures.

### SUMMARY

In one embodiment, a coated cellulosic structure includes a cellulosic substrate and a coating applied to the cellulosic substrate. The coating includes a binder component consisting essentially of one or more water-soluble polymers and a pigment component comprising at least 50 percent by weight clay.

In another embodiment, a coated cellulosic structure includes a cellulosic substrate and a coating applied to the cellulosic substrate. The coating includes a binder component consisting essentially of one or more water-soluble polymers, wherein the water-soluble polymer comprises non-ethylated starch, a pigment component, and a crosslinker, wherein the crosslinker comprises a zirconium-based crosslinker.

Other embodiments of the disclosed coated cellulosic structures will become apparent from the following detailed description, the accompanying drawings and the appended claims.

### BRIEF DESCRIPTION OF THE DRAWINGS

FIG. 1 is a cross-sectional view of a coated cellulosic structure of the present description including a cellulosic substrate and a basecoat applied to the cellulosic substrate to yield a basecoat outer surface.

FIG. 2 is a cross-sectional view of a coated cellulosic structure of the present description including a cellulosic substrate, a basecoat applied to the cellulosic substrate to yield a basecoat outer surface, and a topcoat applied over the basecoat to yield a topcoat outer surface.

FIG. 3 is a cross-sectional view of a coated cellulosic structure of the present description including a cellulosic substrate and a coating applied to the cellulosic substrate to yield a coating outer surface.

FIG. 4 is a graph showing effects of pigment, starch, crosslinker, and humectant on stress buildup during drying.

FIG. 5 is a graph showing effects of crosslinker amount.

FIG. 6 is a graph showing water resistance for blends of coarse carbonate and clay without crosslinker.

### DETAILED DESCRIPTION

Replacing latex with a sustainable recyclable binder in paper coatings is a long-standing environmental goal. Additionally, latex represents a large portion of coating costs. Starch is a natural polymer industrially available in large enough quantities to commercially replace latex. There are three key reasons why this has not been accomplished. Natural binders are water soluble polymers that are brittle and inflexible when formed into a dried film. Water soluble polymers also experience a high degree of shrinkage during drying which, in combination with brittleness and inflexibility, results in coatings that crack and have rough surfaces. When these coatings encounter water, the binders redissolve causing a loss of strength and integrity. Starch is commonly used to replace a minority portion of latex in paper coatings, but the level is severely limited by the properties listed above. A crosslinker is often used to inhibit redissolution, but only have worked sufficiently when most of the total binder is latex.

The present description describes a novel methodology to formulate starch-based binder coating systems with no latex that overcome the issues of resolubility, shrinkage and brittleness. The terms “natural coating” and “natural binder” may be used to describe coatings and binders with no latex.

According to the present description, a coated cellulosic structure includes a cellulosic substrate and a coating applied to the cellulosic substrate.

The cellulosic substrate may be selected from any cellulosic substrate suitable for applying the coating thereon. The cellulosic substrate may be, for example, a paper substrate or a paperboard substrate. The cellulosic substrate may be a single layer of paper or paperboard. The cellulosic substrate (e.g., paper substrate or a paperboard substrate) may be bleached or unbleached. The cellulosic substrate (e.g., paper substrate or a paperboard substrate) may include any grade of paper suitable for applying a coating thereon. The cellulosic substrate (e.g., paper substrate or a paperboard substrate) may include, for example, corrugating medium, linerboard, solid bleached sulfate (SBS), folding boxboard (FBB), coated unbleached kraft (CUK), and recycled cellulosic.

The cellulosic substrate (e.g., paper substrate or a paperboard substrate) may include any uncoated basis weight suitable for applying a coating thereon. The cellulosic substrate (e.g., paper substrate or a paperboard substrate) may have, for example, an uncoated basis weight of 20 pounds per 3000 ft² or more. For example, the cellulosic substrate (e.g., paper substrate or a paperboard substrate) may have an uncoated basis weight in the range of 20 pounds per 3000 ft² to about 400 pounds per 3000 ft². In a specific example, the cellulosic substrate (e.g., paper substrate or a paperboard substrate) may have an uncoated basis weight in the range of 20 pounds per 3000 ft² to about 60 pounds per 3000 ft². In another specific example, the cellulosic substrate (e.g., paper substrate or a paperboard substrate) may have an uncoated basis weight in the range of 60 pounds per 3000 ft² to about 120 pounds per 3000 ft². In another specific example, the cellulosic substrate (e.g., paper substrate or a paperboard substrate) may have an uncoated basis weight in the range of 100 pounds per 3000 ft² to about 250 pounds per 3000 ft². In another specific example, the cellulosic substrate (e.g., paper substrate or a paperboard substrate) may have an uncoated basis weight in the range of 120 pounds per 3000 ft² to about 140 pounds per 3000 ft².

The cellulosic substrate (e.g., paper substrate or a paperboard substrate) may include any thickness suitable for applying a coating thereon. The cellulosic substrate (e.g., paper substrate or a paperboard substrate) may have, for example, an average caliper thickness of 0.002 inch or greater (2 point or greater). In a specific example, the cellulosic substrate (e.g., paper substrate or a paperboard substrate) may have an average caliper thickness in the range of 0.002 inch to 0.035 inch (2 point to 35 point). In another specific example, the cellulosic substrate (e.g., paper substrate or a paperboard substrate) may have an average caliper thickness in the range of 0.008 inch to 0.026 inch (8 point to 26 point).

The coating of the present description may be, for example, one or more of a basecoat and a topcoat of a multi coated cellulosic structure, or the coating may be a single coating of a single coated cellulosic structure.

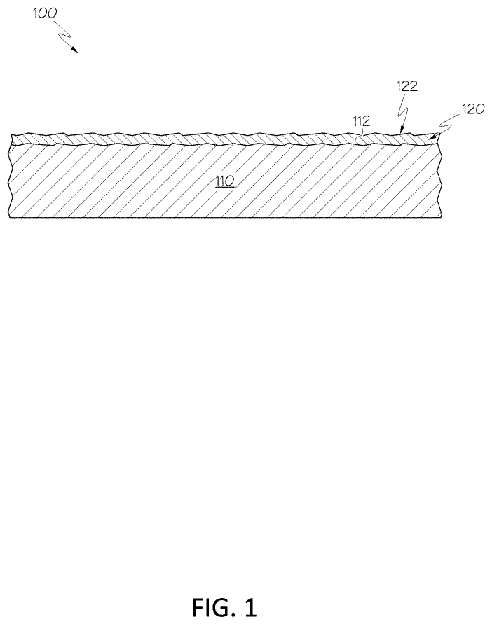

FIG. 1 is a cross-sectional view of a coated cellulosic structure 100 according to a first embodiment of the present description. As shown in FIG. 1, the coated cellulosic structure 100 includes a cellulosic substrate 110 and a basecoat 120 applied to a surface 112 of the cellulosic substrate 110 to yield a basecoat outer surface 122.

Referring to FIG. 1, the basecoat 120 is a coating intended to have at least one or more coatings applied over it in a final coated cellulosic product. The basecoat 120 is different from a topcoat and different from a single coating of a single-coated product because the basecoat 120 is applied at an intermediate stage in the coating process. A basecoat 120 is not processed the same as a topcoat or a single-coated product. The basecoat 120 has one or more coatings applied over it in a final coated cellulosic product, whereas the topcoat or the single-coated product are subjected to post processing (e.g., calendering, printing, and converting).

Referring to FIG. 1, the basecoat 120 may be applied to the cellulosic substrate 110 in any amount suitable for the intended use of the coated cellulosic structure 100. In an example, the basecoat 120 may be applied to the cellulosic substrate 110 at a coat weight, per side, in a range of 4 to 12 pounds per 3000 square feet of the cellulosic substrate 110. In another example, the basecoat 120 may be applied to the cellulosic substrate 110 at a coat weight, per side, in a range of 5 to 11 pounds per 3000 square feet of the cellulosic substrate 110. In yet another example, the basecoat 120 may be applied to the cellulosic substrate 110 at a coat weight, per side, in a range of 6 to 10 pounds per 3000 square feet of the cellulosic substrate 110.

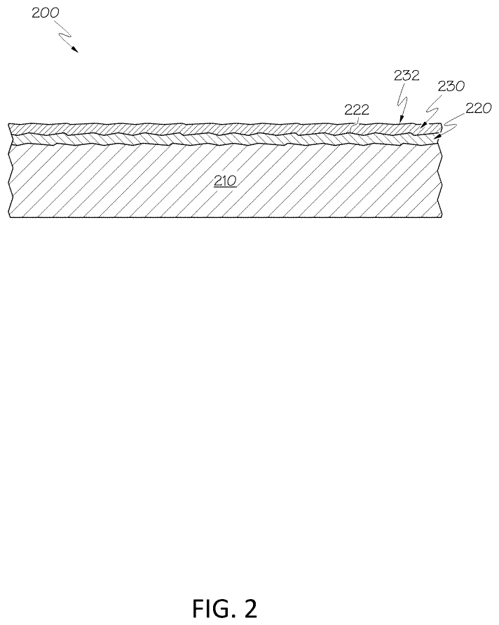

FIG. 2 is a cross-sectional view of a coated cellulosic structure 200 according to a second embodiment of the present description. As shown in FIG. 2, the coated cellulosic structure 200 includes a cellulosic substrate 210, a basecoat 220 applied to the cellulosic substrate 210 to yield a basecoat outer surface 222, and a topcoat 230 applied over the basecoat 220 to yield a topcoat outer surface 232.

Referring to FIG. 2, the basecoat 220 may be applied to the cellulosic substrate 210 in any amount suitable for the intended use of the coated cellulosic structure 200. In an example, the basecoat 220 may be applied to the cellulosic substrate 210 at a coat weight, per side, in a range of 4 to 12 pounds per 3000 square feet of the cellulosic substrate 210. In another example, the basecoat 220 may be applied to the cellulosic substrate 210 at a coat weight, per side, in a range of 5 to 11 pounds per 3000 square feet of the cellulosic substrate 210. In yet another example, the basecoat 220 may be applied to the cellulosic substrate 210 at a coat weight, per side, in a range of 6 to 10 pounds per 3000 square feet of the cellulosic substrate 210.

Referring to FIG. 2, the topcoat 230 may be applied directly on the basecoat outer surface 222 without any intermediate layers. In another aspect, one or more intermediate layers may be included between the basecoat 220 and the topcoat 230. In an example, a second basecoat may be included between the basecoat 220 and the topcoat 230. In another example, a barrier layer may be included between the basecoat 220 and the topcoat 230.

Referring to FIG. 2, the topcoat 230 may be applied to the cellulosic substrate 210 in any amount suitable for the intended use of the coated cellulosic structure 200. In an example, the topcoat 230 may be applied to the cellulosic substrate 210 at a coat weight, per side, in a range of 3 to 12 pounds per 3000 square feet of the cellulosic substrate 210. In another example, the topcoat 230 may be applied to the cellulosic substrate 210 at a coat weight, per side, in a range of 4 to 11 pounds per 3000 square feet of the cellulosic substrate 210. In yet another example, the topcoat 230 may be applied to the cellulosic substrate 210 at a coat weight, per side, in a range of 5 to 10 pounds per 3000 square feet of the cellulosic substrate 210.

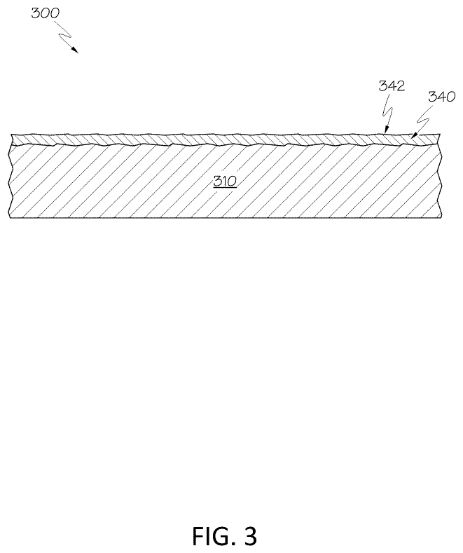

FIG. 3 is a cross-sectional view of a single coated cellulosic structure 300 according to a third embodiment of the present description. As shown in FIG. 3, the single coated cellulosic structure 300 includes a cellulosic substrate 310 and a single coating 340 applied to the cellulosic substrate 310 to yield a coating outer surface 342.

Referring to FIG. 3, the single coating 340 is intended to yield a coating outer surface 342 of the coated cellulosic structure 300. The single coating 340 is different from a basecoat. A basecoat is not processed the same as a single-coated product. A basecoat has one or more coatings applied over it in a final coated cellulosic product, whereas the single-coated product are subjected to post processing (e.g., calendering, printing, and converting).

Referring to FIG. 3, the single coating 340 may be applied to the cellulosic substrate 310 in any amount suitable for the intended use of the coated cellulosic structure 300. In an example, the single coating 340 may be applied to the cellulosic substrate 310 at a coat weight, per side, in a range of 3 to 12 pounds per 3000 square feet of the cellulosic substrate 310. In another example, the single coating 340 may be applied to the cellulosic substrate 310 at a coat weight, per side, in a range of 4 to 11 pounds per 3000 square feet of the cellulosic substrate 310. In yet another example, the coating 340 may be applied to the cellulosic substrate 310 at a coat weight, per side, in a range of 5 to 10 pounds per 3000 square feet of the cellulosic substrate 310.

According to the present description, at least one coating (e.g., basecoat, intermediate coat, topcoat or single coating) is a coating as defined hereafter. In an aspect, more than one coating is a coating as defined hereafter. In a particular aspect, all of the coatings are coatings as defined hereafter.

According to the present description, the at least one coating of the present description includes a binder component and a pigment component, wherein the binder component comprises all binders in the coating, and wherein the pigment component comprises all pigments in the coating.

The binder component consists essentially of one or more water-soluble polymers, preferably at least 80 percent by weight of one or more water-soluble polymers, preferably at least 90 percent by weight of one or more water-soluble polymers, more preferably at least 95 percent by weight of one or more water-soluble polymers, more preferably at least 98 percent by weight of one or more water-soluble polymers, more preferably at least 99 percent by weight of one or more water-soluble polymers, more preferably 100 percent by weight of one or more water-soluble polymers. The binder component may consist of a single water-soluble polymer binder composition or may include a blend of water-soluble polymer binder compositions.

In an aspect, the coating or coatings may be latex-free. In a particular aspect, all of the coatings may be latex-free. An advantage of the coated cellulosic structure with water-soluble polymer binders and no latex binder is highly compostable of the resulting coated cellulosic structure.

In an aspect, the water-soluble polymer binder includes a carbohydrate, which may be in the form of cellulose derivative. The carbohydrate may be in the form of starch. The starch may be derived from, for example, corn or potatoes. In an aspect, the binder component may preferably be at least 80 percent by weight starch, more preferably at least 80 percent by weight starch, more preferably at least 90 percent by weight starch, more preferably about 100 percent by weight starch.

The starch may preferably include or be non-ethylated starch, preferably non-alkylated starch. The starch may preferably include or be oxidized starch. It was found through experimental evidence by the present inventors that non-ethylated starch (e.g., oxidized starch) has a tendency for improved resistance to redissolving compared with ethylated starch. This tendency is particularly pronounced when employed in a coating having a high clay content and/or a crosslinker, particularly a zirconium-based crosslinker. The starch is preferably non-functionalized starch. In an aspect, the binder component may preferably be at least 80 percent by weight of the oxidized starch, more preferably at least 80 percent by weight oxidized starch, more preferably at least 90 percent by weight oxidized starch, more preferably about 100 percent by weight oxidized starch. The experimental evidence tested oxidized starch but it is believe that other types of non-ethylated starch may show improved resistance to redissolving compared with ethylated starch.

The pigment component may comprise preferably at least 10 percent by weight clay, more preferably at least 20 percent by weight clay, more preferably at least 30 percent by weight clay, more preferably at least 40 percent by weight clay, more preferably at least 50 percent by weight clay, more preferably at least 60 percent by weight clay, more preferably at least 70 percent by weight clay, more preferably at least 80 percent by weight clay, more preferably at least 90 percent by weight clay, more preferably at least 80 percent by weight clay, more preferably about 100 percent by weight clay. The clay may include kaolin clay. It was found through experimental evidence by the present inventors that a high clay content in the pigment component has a tendency for improving resistance of starch to redissolving compared with other pigments, particularly calcium carbonate. This tendency is particularly pronounced when employed in a coating having a non-ethylated starch, preferably non-alkylated starch, such as oxidized starch, and/or a crosslinker, particularly a zirconium-based crosslinker.

In an aspect, the pigment component may include additional inorganic pigments other than clay. In particular, the additional inorganic pigments may include or be calcium carbonate.

The pigment component may be a fine pigment component or a coarse pigment component. The fine pigment component may be characterized such that more than 75 percent of the pigment particles are less than 2 microns in diameter. The coarse pigment component may be characterized such that less than 75 percent of the clay particles are less than 2 microns in diameter. The median particle diameter is the median particle diameter as measured by a sedimentation-based method, i.e., the SediGraph by Micromeritics.

The relative amounts of the binder component and the pigment component may depend on method of coating application and other parameters. In an example, a ratio of the binder component to the pigment component may be less than 1:1 by weight. In another example, a ratio of the binder component to the pigment component may be in a range of 1:2 to 1:20 by weight. In yet another example, a ratio of the binder component to the pigment component may be in a range of 1:3 to 1:7 by weight. In yet another example, a ratio of the binder component to the pigment component may be in a range of 1:4 to 1:5 by weight. In another expression, the binder-to-pigment ratio may be 10-30 parts binder component per 100 parts pigment component. In another expression, the binder-to-pigment ratio may be 15-25 parts binder component per 100 parts pigment component, which may be particularly preferred for a basecoat. In another expression, the binder-to-pigment ratio may be 10-20 parts binder component per 100 parts pigment component, which may be particularly preferred for a topcoat.

The coatings may include additives other than the water-soluble polymer binder and the pigment to improve or enhance their performance.

In an aspect, the coatings may include a crosslinker (also referred to as insolubilizer). The crosslinker causes the water-soluble polymer binder molecules to bond with each other upon drying.

In an example, the crosslinker may include a glyoxal-based crosslinker. In another example, the crosslinker may include a zirconium-based crosslinker. In yet another example, the crosslinker may include a glyoxal-based crosslinker and a zirconium-based crosslinker. The amount of the crosslinker is not limited. In an example, the crosslinker may be included in an amount of 1% to 20% by weight of the amount of water-soluble polymer binder. In another example, the crosslinker may be included in an amount of 1% to 10% by weight of the amount of water-soluble polymer binder. In another example, the crosslinker may be included in an amount of 1% to 8% by weight of the amount of water-soluble polymer binder. In yet another example, the crosslinker may be included in an amount of 1% to 6% by weight of the amount of water-soluble polymer binder. In yet another example, the crosslinker may be included in an amount of 8% to 10% by weight of the amount of water-soluble polymer binder.

The crosslinker preferably includes a zirconium-based crosslinker, particularly ammonium zirconium carbonate (AZC). It was found through experimental evidence by the present inventors that ammonium zirconium carbonate (AZC) has a tendency for improving resistance of starch to redissolving compared with a glyoxal-based crosslinker. This tendency is particularly pronounced when employed in a coating having a non-ethylated starch (e.g., oxidized starch) and/or a high clay content. The ammonium zirconium carbonate (AZC) crosslinker may be included in an amount of 1% to 20% by weight of the amount of water-soluble polymer binder. In another example, the ammonium zirconium carbonate (AZC) crosslinker may be included in an amount of 1% to 10% by weight of the amount of water-soluble polymer binder. In another example, the ammonium zirconium carbonate (AZC) crosslinker may be included in an amount of 1% to 8% by weight of the amount of water-soluble polymer binder. In yet another example, the ammonium zirconium carbonate (AZC) crosslinker may be included in an amount of 1% to 6% by weight of the amount of water-soluble polymer binder. In yet another example, the ammonium zirconium carbonate (AZC) crosslinker may be included in an amount of 8% to 10% by weight of the amount of water-soluble polymer binder.

In another aspect, the coatings may include a humectant (water loving material) that functions as a plasticizer for the water-soluble polymer binder by retaining water in the dried coating.

In an example, the humectant may include a humectant in form of glycerin. In another example, the humectant may include a humectant in form of sorbitol. In yet another example, the humectant may include a humectant in form of glycerin and sorbitol. The amount of the humectant is not limited. In an example, the humectant may be included in an amount of 1% to 30% by weight of the amount of water-soluble polymer binder. In another example, the humectant may be included in an amount of 5% to 30% by weight of the amount of water-soluble polymer binder. In yet another example, the humectant may be included in an amount of 5% to 15% by weight of the amount of water-soluble polymer binder. In yet another example, the humectant may be included in an amount of 15% to 25% by weight of the amount of water-soluble polymer binder. In yet another example, the humectant may be included in an amount of 25% to 30% by weight of the amount of water-soluble polymer binder.

### Experimental Results

One of the many issues hindering the development of natural coatings is the lack of tests to predict performance for printing and converting. The test that is widely used is the Adams wet rub test, which is primitive and is used on coated sheets. This method involves rubbing a strip of coated paper with a hard wet wheel for a period of time and measuring the turbidity of the water to indicate how much the coating disintegrated. Its use for screening formulations in the lab is very limited because of the difficulty and time required to make accurate, reproducible coated sheets in the lab.

### Interactions Between Pigments, Starch and Crosslinker

An initial designed experiment was used to determine the interactions between key variables. The experimental conditions were:
Pigments (3)—All-carbonate, 50/50 clay/carbonate, and all #2 clay
Binder Level (3)—15, 20 and 25 parts starch
Crosslinker (2)—4% glyoxal or 8% AZC based on starch

Table 1 summarizes the results. A rating system with 10 levels was used to compare the samples. The ranges were set based on previous results.

TABLE 1

| | | | |
|---|---|---|---|
| Starch | None | 4% Glyoxal | 8% AZC |

All-Hydrocarb 60

| | | | |
|---|---|---|---|
| 15 pts | 1383 | 1224 | 225 |
| 20 pts | 418 | 682 | 188 |
| 25 pts | 624 | 131 | 293 |

50/50 Blend Hydrocarb 60/Kaobrite #2 clay

| | | | |
|---|---|---|---|
| 15 pts | 160 | 79 | 29 |
| 20 pts | 94 | 176 | 28 |
| 25 pts | 145 | 54 | 18 |

All-Kaobrite #2 Clay

| | | | |
|---|---|---|---|
| 15 pts | 18 | 0 | 12 |
| 20 pts | 9 | 0 | 0 |
| 25 pts | 0 | 0 | 0 |

The largest effect was due to pigment. The difference between clay and carbonate is profound. The data suggests that carbonate interferes with crosslinking. Even with crosslinker, the values are all poor, regardless of binder level. Clay promotes crosslinking. Even without crosslinker, the all-clay formulations had good water resistance. For a 50/50 blend, acceptable values can be obtained using AZC.

AZC performed much better than glyoxal. Glyoxal had only a very slight effect.

The data tends to show that 15 parts starch is not sufficient to bind coatings if carbonate is present.

To confirm that the same relationships hold true for fine pigments, a fine GCC was used with Hydragloss 91, a fine clay. The glyoxal portion of the experiment was not repeated. Referring to Table 2, the results were very similar, showing the same interactions and effects.

TABLE 2

| | | |
|---|---|---|
| 15 parts | 20 parts | 25 parts |

All-Hydrocarb 90

| | | | |
|---|---|---|---|
| No Crosslinker | 929 | 445 | 553 |
| 8% AZC on Starch | 156 | 298 | 231 |

50/50 Blend Hydrocarb 90/Hydragloss 91 clay

| | | | |
|---|---|---|---|
| No Crosslinker | 132 | 194 | 182 |
| 8% AZC on Starch | 78 | 68 | 36 |

All-Hydragloss 91 Fine Clay

| | | | |
|---|---|---|---|
| No Crosslinker | 61 | 33 | 24 |
| 8% AZC on Starch | 42 | 36 | 23 |

### Stress Measurements

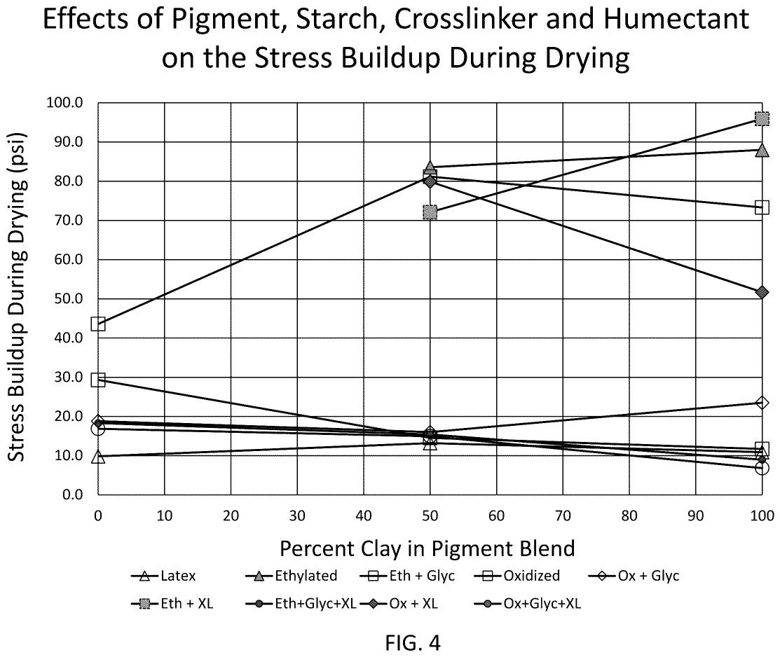

FIG. 4 shows results from measuring the stress that occurs when a coating is dried. It was found that the use of a humectant (water loving material) reduces shrinkage.

### Crosslinker Performance

An additional sequential series of experiments were performed to evaluate crosslinker performance. A 50/50 blend of coarse GCC and #2 clay was used. The experiments were limited to Sequarez 755, a glyoxal-based crosslinker, and AZC. These are two materials that have been proven effective in the past and are FDA approved. The experiment was intended to optimize the crosslinker addition level. The level of glyoxal, AZC and 50/50 blends (S8) were varied. These results show glyoxal does not crosslink as well as AZC. Even at the maximum allowable limit, glyoxal had a limited response.

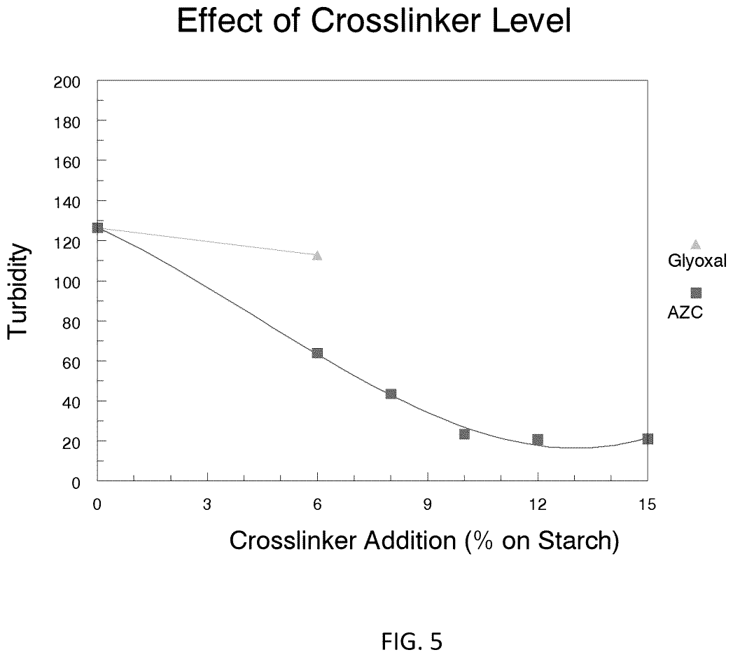

FIG. 5 is a graph showing the effects of crosslinker amount. The resistance to resolubilization reached a minimum between 8 and 10% AZC. The effect of AZC continued to increase linearly withing the range tested.

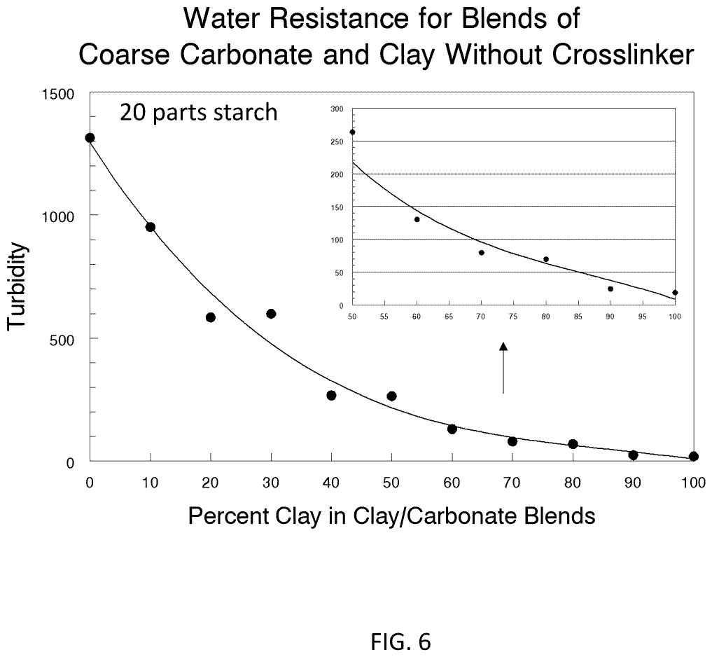

FIG. 6 is a graph showing water resistance for blends of coarse carbonate and clay without crosslinker. Referring to FIG. 6, further testing showed the effect of carbonate addition is nonlinear. Any carbonate level increases turbidity, but the increase is greater for 50% or greater.

### Turbidity Testing Matrix

After these initial tests, a further test procedure was developed to screen formulations in the lab that does not require the coatings to be applied to a substrate. The testing matrix allowed for screening a large number of formulations. Wafers of dried coating were made in the lab and subjected to prolonged exposure to water, then turbidity was used to measure the results. The experiments generated unexpected and unique results.

A series of lab experiments were performed to establish the fundamental interactions between pigment type, binder level, crosslinkers and the type of starch used. The lab test that was developed allowed for the performance of a large number of tests. A description of the test follows. A low turbidity number is good. By comparison, latex gives a zero turbidity.

The following turbidity test procedure was developed. Coatings were made in the lab using jet-cooked starch. For these large experiments, the binder level was 25 parts for coarse pigments and 20 parts for fine pigments. Glyoxal was added as 4% based on starch. AZC was added as 8% based on starch. Silicone trays, meant to be candy molds, with square cups that are roughly 1.5 inches on a side, were used. Each tray holds 4 rows of 6 cups. For each sample, 6 cups were filled with 10 g of coating. The trays were placed in a 150 degree F. oven overnight to dry. The dried trays were then place in a 220 degree F. oven for 3 hours to cure. 500 ml sample bottles were filled with 300 g of distilled water. The cured samples were in the form of small square “biscuits.” Five biscuits for each sample were individually placed in a bottle of water and left on a bottle roller for 15 minutes. After 15 minutes, a sample of the liquid from each bottle was collected and tested for turbidity. The average turbidity is used as a measure of resistance to resolubilization of the starch. Table 3 lists the turbidity for the experiments that were conducted.

TABLE 3
Coarse pigments with ethylated starch

| % Clay | E 2015 | | |
|---|---|---|---|
| in | No | E 2015 | E 2015 |
| blend | Xlinker | Glyoxal | AZC |
| 0 | 901 | 258 | 221 |
| 10 | 876 | 207 | 103 |
| 20 | 682 | 215 | 79 |
| 30 | 524 | 195 | 24 |
| 40 | 245 | 284 | 35 |
| 50 | 149 | 206 | 23 |
| 60 | 137 | 95 | 32 |
| 70 | 81 | 21 | 16 |
| 80 | 68 | 37 | 17 |
| 90 | 33 | 29 | 12 |
| 100 | 23 | 0 | 4 |

Coarse pigments with oxidized starch

| % Clay | Oxidized | | |
|---|---|---|---|
| in | No | Oxidized | Oxidized |
| blend | Xlinker | Glyoxal | AZC |
| 0 | 607 | 206 | 48 |
| 10 | 430 | 286 | 55 |
| 20 | 392 | 103 | 47 |
| 30 | 178 | 29 | 30 |
| 40 | 52 | 35 | 16 |
| 50 | 36 | 31 | 6 |
| 60 | 30 | 14 | 4 |
| 70 | 22 | 14 | 11 |
| 80 | 15 | 9 | 10 |
| 90 | 17 | 0 | 4 |
| 100 | 16 | 9 | 4 |

Fine pigments with ethylated starch

| % Clay | Ethylated | | |
|---|---|---|---|
| in | No | Ethylated | Ethylated |
| blend | Xlinker | Glyoxal | AZC |
| 0 | 1782 | 348 | 102 |
| 10 | 1023 | 169 | 136 |
| 20 | 576 | 161 | 108 |
| 30 | 633 | 45 | 49 |
| 40 | 409 | 38 | 50 |
| 50 | 197 | 22 | 23 |
| 60 | 100 | 18 | 11 |
| 70 | 48 | 14 | 18 |
| 80 | 22 | 8 | 7 |
| 90 | 24 | 6 | 11 |
| 100 | 19 | 2 | 17 |

Fine pigments with oxidized starch

| % Clay | Oxidized | | |
|---|---|---|---|
| in | No | Oxidized | Oxidized |
| blend | Xlinker | Glyoxal | AZC |
| 0 | 1880 | 283 | 6 |
| 10 | 1500 | 593 | 5 |
| 20 | 1156 | 359 | 17 |
| 30 | 556 | 228 | 7 |
| 40 | 404 | 246 | 9 |
| 50 | 219 | 79 | 10 |
| 60 | 99 | 71 | 2 |
| 70 | 32 | 12 | 4 |
| 80 | 22 | 6 | 4 |
| 90 | 28 | 6 | 3 |
| 100 | 25 | 2 | 1 |

Table 4 uses the data from Table 1 and a turbidity of 30 as a preferred upper acceptable limit, independent of pigment size, to define preferred coating compositions. According to Table 2, samples with at least 80% clay had preferred turbidity, samples with at least 70% clay and a crosslinker had preferred turbidity, samples with at least 70% clay and oxidized starch had preferred turbidity, samples with oxidized starch and AZC crosslinker had preferred turbidity, and samples with oxidized starch and AZC crosslinker and at least 30% clay had preferred turbidity.

TABLE 4

| Coarse pigments with ethylated starch | | | | Coarse pigments with oxidized starch | | | |
|---|---|---|---|---|---|---|---|
| % Clay | E 2015 | | | % Clay | Oxidized | | |
| in | No | E 2015 | E 2015 | in | No | Oxidized | Oxidized |
| blend | Xlinker | Glyoxal | AZC | blend | Xlinker | Glyoxal | AZC |
| 0 | | | | 0 | | | |
| 10 | | | | 10 | | | |
| 20 | | | | 20 | | | |
| 30 | | | | 30 | | | |
| 40 | | | | 40 | | | |
| 50 | | | | 50 | | | |
| 60 | | | | 60 | | | |
| 70 | | | | 70 | | | |
| 80 | | | | 80 | | | |
| 90 | | | | 90 | | | |
| 100 | | | | 100 | | | |

The above experimental results show combinations of factors that solve the previously identified challenges with regards to sustainable coatings. By selection of binder component, pigment component, and crosslinker, improvements in properties of sustainable coatings can be achieved.

Further, the disclosure comprises examples according to the following clauses:

Clause 1. A coated cellulosic structure comprising: a cellulosic substrate; and a coating applied to the cellulosic substrate, the coating comprising: a binder component consisting essentially of one or more water-soluble polymers; and a pigment component comprising at least 50 percent by weight clay.

Clause 2. The coated cellulosic structure of Clause 1, wherein the cellulosic substrate is bleached.

Clause 3. The coated cellulosic structure of Clause 1, wherein the cellulosic substrate is unbleached.

Clause 4. The coated cellulosic structure of any preceding clause, wherein the cellulosic substrate includes paper or paperboard.

Clause 5. The coated cellulosic structure of any preceding clause, wherein the cellulosic substrate is a single layer of paper or paperboard.

Clause 6. The coated cellulosic structure of any preceding clause, wherein the cellulosic substrate includes one or more of corrugating medium, linerboard, solid bleached sulfate (SBS), folding boxboard (FBB), coated unbleached kraft (CUK), and recycled paper or paperboard.

Clause 7. The coated cellulosic structure of any preceding clause, wherein the cellulosic substrate has an uncoated basis weight of 20 pounds per 3000 ft² or more.

Clause 8. The coated cellulosic structure of any preceding clause, wherein the cellulosic substrate has an uncoated basis weight in a range of 20 pounds per 3000 ft² to about 400 pounds per 3000 ft².

Clause 9. The coated cellulosic structure of any preceding clause, wherein the cellulosic substrate has an uncoated basis weight in a range of 100 pounds per 3000 ft² to about 250 pounds per 3000 ft².

Clause 10. The coated cellulosic structure of any preceding clause, wherein the cellulosic substrate has an uncoated basis weight in a range of 120 pounds per 3000 ft² to about 140 pounds per 3000 ft².

Clause 11. The coated cellulosic structure of any preceding clause, wherein the cellulosic substrate has an average caliper thickness of 0.002 inch or greater (2 point or greater).

Clause 12. The coated cellulosic structure of any preceding clause, wherein the cellulosic substrate has an average caliper thickness in a range of 0.002 inch to 0.035 inch (2 point to 35 point).

Clause 13. The coated cellulosic structure of any preceding clause, wherein the cellulosic substrate has an average caliper thickness in a range of 0.008 inch to 0.026 inch (8 point to 26 point).

Clause 14. The coated cellulosic structure of any preceding clause, wherein the one or more water-soluble polymers comprises a carbohydrate.

Clause 15. The coated cellulosic structure of any preceding clause, wherein the one or more water-soluble polymers comprises starch.

Clause 16. The coated cellulosic structure of any preceding clause, wherein the binder component is at least 80 percent by weight starch.

Clause 17. The coated cellulosic structure of any preceding clause, wherein the binder component is at least 90 percent by weight starch.

Clause 18. The coated cellulosic structure of any preceding clause, wherein the binder component is about 100 percent by weight starch.

Clause 19. The coated cellulosic structure of any preceding clause, wherein the one or more water-soluble polymers comprises non-ethylated starch.

Clause 20. The coated cellulosic structure of any one of Clauses 1-18, wherein the one or more water-soluble polymers comprises non-alkylated starch.

Clause 21. The coated cellulosic structure of any one of Clauses 1-18, wherein the one or more water-soluble polymers comprises oxidized starch.

Clause 22. The coated cellulosic structure of any one of Clauses 1-18, wherein the one or more water-soluble polymers comprises non-functionalized starch.

Clause 23. The coated cellulosic structure of any preceding clause, wherein pigment component comprises at least 60 percent by weight clay.

Clause 24. The coated cellulosic structure of any preceding clause, wherein pigment component comprises at least 70 percent by weight clay.

Clause 25. The coated cellulosic structure of any preceding clause, wherein pigment component comprises at least 80 percent by weight clay.

Clause 26. The coated cellulosic structure of any preceding clause, wherein pigment component comprises at least 90 percent by weight clay.

Clause 27. The coated cellulosic structure of any preceding clause, wherein pigment component comprises about 100 percent by weight clay.

Clause 28. The coated cellulosic structure of any preceding clause, wherein the clay includes kaolin clay.

Clause 29. The coated cellulosic structure of any preceding clause, wherein more than 75 percent of particles of the pigment component are less than 2 microns in diameter.

Clause 30. The coated cellulosic structure of any preceding clause, wherein less than 75 percent of particles of the pigment component are less than 2 microns in diameter.

Clause 31. The coated cellulosic structure of any preceding clause, wherein a ratio of the binder component to the pigment component is less than 1:1 by weight.

Clause 32. The coated cellulosic structure of any preceding clause, wherein a ratio of the binder component to the pigment component is in a range of 1:2 to 1:20 by weight.

Clause 33. The coated cellulosic structure of any preceding clause, wherein a ratio of the binder component to the pigment component is in a range of 1:3 to 1:7 by weight.

Clause 34. The coated cellulosic structure of any preceding clause, wherein a ratio of the binder component to the pigment component is in a range of 1:4 to 1:5 by weight.

Clause 35. The coated cellulosic structure of any preceding clause, wherein the coating further comprises a crosslinker.

Clause 36. The coated cellulosic structure of any one of Clauses 1-35, wherein the coating further comprises a crosslinker, wherein the crosslinker is a glyoxal-based crosslinker.

Clause 37. The coated cellulosic structure of any one of Clauses 1-35, wherein the coating further comprises a crosslinker, wherein the crosslinker is a zirconium-based crosslinker.

Clause 38. The coated cellulosic structure of any preceding clause, wherein the coating further comprises a crosslinker in an amount of 1% to 12% by weight of the amount of water-soluble polymer binder.

Clause 39. The coated cellulosic structure of any preceding clause, wherein the coating further comprises a crosslinker in an amount of 2% to 6% by weight of the amount of water-soluble polymer binder.

Clause 40. The coated cellulosic structure of any preceding clause, wherein the coating further comprises a crosslinker in an amount of 4% to 8% by weight of the amount of water-soluble polymer binder.

Clause 41. The coated cellulosic structure of any preceding clause, wherein the coating is latex-free.

Clause 42. A coated cellulosic structure comprising: a cellulosic substrate; and a coating applied to the cellulosic substrate, the coating comprising: a binder component consisting essentially of one or more water-soluble polymers, wherein the water-soluble polymer comprises non-ethylated starch; a pigment component; and a crosslinker, wherein the crosslinker comprises a zirconium-based crosslinker.

Clause 43. The coated cellulosic structure of Clause 42 wherein the cellulosic substrate is bleached.

Clause 44. The coated cellulosic structure of Clause 42 wherein the cellulosic substrate is unbleached.

Clause 45. The coated cellulosic structure of any one of Clauses 42-44, wherein the cellulosic substrate includes paper or paperboard.

Clause 46. The coated cellulosic structure of any one of Clauses 42-45, wherein the cellulosic substrate is a single layer of paper or paperboard.

Clause 47. The coated cellulosic structure of any one of Clauses 42-46, wherein the cellulosic substrate includes one or more of corrugating medium, linerboard, solid bleached sulfate (SBS), folding boxboard (FBB), coated unbleached kraft (CUK), and recycled paper or paperboard.

Clause 48. The coated cellulosic structure of any one of Clauses 42-47, wherein the cellulosic substrate has an uncoated basis weight of 20 pounds per 3000 ft² or more.

Clause 49. The coated cellulosic structure of any one of Clauses 42-47, wherein the cellulosic substrate has an uncoated basis weight in a range of 20 pounds per 3000 ft² to about 400 pounds per 3000 ft².

Clause 50. The coated cellulosic structure of any one of Clauses 42-47, wherein the cellulosic substrate has an uncoated basis weight in a range of 100 pounds per 3000 ft² to about 250 pounds per 3000 ft².

Clause 51. The coated cellulosic structure of any one of Clauses 42-47, wherein the cellulosic substrate has an uncoated basis weight in a range of 120 pounds per 3000 ft² to about 140 pounds per 3000 ft².

Clause 52. The coated cellulosic structure of any one of Clauses 42-51, wherein the cellulosic substrate has an average caliper thickness of 0.002 inch or greater (2 point or greater).

Clause 53. The coated cellulosic structure of any one of Clauses 42-51, wherein the cellulosic substrate has an average caliper thickness in a range of 0.002 inch to 0.035 inch (2 point to 35 point).

Clause 54. The coated cellulosic structure of any one of Clauses 42-51, wherein the cellulosic substrate has an average caliper thickness in a range of 0.008 inch to 0.026 inch (8 point to 26 point).

Clause 55. The coated cellulosic structure of any one of Clauses 42-54, wherein the binder component is at least 80 percent by weight starch.

Clause 56. The coated cellulosic structure of any one of Clauses 42-54, wherein the binder component is at least 90 percent by weight starch.

Clause 57. The coated cellulosic structure of any one of Clauses 42-54, wherein the binder component is about 100 percent by weight starch.

Clause 58. The coated cellulosic structure of any one of Clauses 42-57, wherein the one or more water-soluble polymers comprises non-alkylated starch.

Clause 59. The coated cellulosic structure of any one of Clauses 42-57, wherein the one or more water-soluble polymers comprises non-functionalized starch.

Clause 60. The coated cellulosic structure of any one of Clauses 42-57, wherein the one or more water-soluble polymers comprises oxidized starch.

Clause 61. The coated cellulosic structure of any one of Clauses 42-60, wherein pigment component comprises at least 10 percent by weight clay.

Clause 62. The coated cellulosic structure of any one of Clauses 42-60, wherein pigment component comprises at least 20 percent by weight clay.

Clause 63. The coated cellulosic structure of any one of Clauses 42-60, wherein pigment component comprises at least 30 percent by weight clay.

Clause 64. The coated cellulosic structure of any one of Clauses 42-60, wherein pigment component comprises at least 40 percent by weight clay.

Clause 65. The coated cellulosic structure of any one of Clauses 42-60, wherein pigment component comprises at least 50 percent by weight clay.

Clause 66. The coated cellulosic structure of any one of Clauses 42-60, wherein pigment component comprises at least 60 percent by weight clay.

Clause 67. The coated cellulosic structure of any one of Clauses 42-60, wherein pigment component comprises at least 70 percent by weight clay.

Clause 68. The coated cellulosic structure of any one of Clauses 42-60, wherein pigment component comprises at least 80 percent by weight clay.

Clause 69. The coated cellulosic structure of any one of Clauses 42-60, wherein pigment component comprises at least 90 percent by weight clay.

Clause 70. The coated cellulosic structure of any one of Clauses 42-60, wherein pigment component comprises about 100 percent by weight clay.

Clause 71. The coated cellulosic structure of any one of Clauses 42-70, wherein the clay includes kaolin clay.

Clause 72. The coated cellulosic structure of any one of Clauses 42-71, wherein more than 75 percent of the clay particles are less than 2 microns in diameter.

Clause 73. The coated cellulosic structure of any one of Clauses 42-71, wherein less than 75 percent of the clay particles are less than 2 microns in diameter.

Clause 74. The coated cellulosic structure of any one of Clauses 42-73, wherein a ratio of the water-soluble polymer binder to the pigment is less than 1:1 by weight.

Clause 75. The coated cellulosic structure of any one of Clauses 42-73, wherein a ratio of the water-soluble polymer binder to the pigment is in a range of 1:2 to 1:20 by weight.

Clause 76. The coated cellulosic structure of any one of Clauses 42-73, wherein a ratio of the water-soluble polymer binder to the pigment is in a range of 1:3 to 1:7 by weight.

Clause 77. The coated cellulosic structure of any one of Clauses 42-73, wherein a ratio of the water-soluble polymer binder to the pigment is in a range of 1:4 to 1:5 by weight.

Clause 78. The coated cellulosic structure of any one of Clauses 42-77, wherein the coating comprises the crosslinker in an amount of 1% to 12% by weight of the amount of water-soluble polymer binder.

Clause 79. The coated cellulosic structure of any one of Clauses 42-77, wherein the coating comprises the crosslinker in an amount of 2% to 6% by weight of the amount of water-soluble polymer binder.

Clause 80. The coated cellulosic structure of any one of Clauses 42-77, wherein the coating comprises the crosslinker in an amount of 4% to 8% by weight of the amount of water-soluble polymer binder.

Clause 81. The coated cellulosic structure of any one of Clauses 42-80, wherein the coating is latex-free.

Although various embodiments of the disclosed coated cellulosic structures have been shown and described, modifications may occur to those skilled in the art upon reading the specification. The present application includes such modifications and is limited only by the scope of the claims.

1. A coated cellulosic structure comprising:
a cellulosic substrate; and
a coating applied to the cellulosic substrate, the coating comprising:
a binder component consisting essentially of one or more water-soluble polymers; and
a pigment component comprising at least 50 percent by weight clay.

2. The coated cellulosic structure of claim 1, wherein the one or more water-soluble polymers comprises a carbohydrate.

3. The coated cellulosic structure of claim 1, wherein the one or more water-soluble polymers comprises starch.

4. The coated cellulosic structure of claim 1, wherein the binder component is at least 80 percent by weight starch.

5. The coated cellulosic structure of claim 1, wherein the one or more water-soluble polymers comprises non-ethylated starch.

6. The coated cellulosic structure of claim 1, wherein the one or more water-soluble polymers comprises non-alkylated starch.

7. The coated cellulosic structure of claim 1, wherein the one or more water-soluble polymers comprises oxidized starch.

8. The coated cellulosic structure of claim 1, wherein the one or more water-soluble polymers comprises non-functionalized starch.

9. The coated cellulosic structure of claim 1, wherein pigment component comprises at least 60 percent by weight clay.

10. The coated cellulosic structure of claim 1, wherein the clay includes kaolin clay.

11. The coated cellulosic structure of claim 1, wherein more than 75 percent of particles of the pigment component are less than 2 microns in diameter.

12. The coated cellulosic structure of claim 1, wherein less than 75 percent of particles of the pigment component are less than 2 microns in diameter.

13. The coated cellulosic structure of claim 1, wherein a ratio of the binder component to the pigment component is less than 1:1 by weight.

14. The coated cellulosic structure of claim 1, wherein a ratio of the binder component to the pigment component is in a range of 1:2 to 1:20 by weight.

15. The coated cellulosic structure of claim 1, wherein the coating further comprises a crosslinker.

16. The coated cellulosic structure of claim 1, wherein the coating further comprises a crosslinker, wherein the crosslinker is a glyoxal-based crosslinker.

17. The coated cellulosic structure of claim 1, wherein the coating further comprises a crosslinker, wherein the crosslinker is a zirconium-based crosslinker.

18. The coated cellulosic structure of claim 1, wherein the coating further comprises a crosslinker in an amount of 1% to 12% by weight of the amount of water-soluble polymer binder.

19. The coated cellulosic structure of claim 1, wherein the coating is latex-free.

20. A coated cellulosic structure comprising:
a cellulosic substrate; and
a coating applied to the cellulosic substrate, the coating comprising:
a binder component consisting essentially of one or more water-soluble polymers, wherein the water-soluble polymer comprises non-ethylated starch;
a pigment component; and
a crosslinker, wherein the crosslinker comprises a zirconium-based crosslinker.
